(19) United States
(12) Patent Application Publication
(10) Pub. No.: US 2003/0179105 A1
(43) Pub. Date: Sep. 25, 2003

(54) Inductive transformer

(76) Inventor: Harald Kazmierczak, Beilstein (DE)

Correspondence Address: Striker Striker & Stenby, 103 East Neck Road, Huntington, NY, 11743, US

(21) Appl. No.: 10/380,594

(22) PCT Filed: Aug. 28, 2001
(86) PCT No.: PCT/DE01/03269

(30) Foreign Application Priority Data
Sep. 20, 2000 (DE) 100 46 659.1

(51) Int. Cl. G08C 19/06

(52) U.S. Cl. 340/870.31; 340/870.1

(57) ABSTRACT

The invention relates to an inductive transmitter for transmitting measurement data and electrical energy between two components (1, 2) that move in relation to each other, having at least one primary (3, 5) and at least one secondary transmitter component (4, 6). There is one transmitter (3, 4) for transmitting measurement data and one transmitter (5, 6) for transmitting electrical energy, with the primary (3, 5) and secondary (4, 6) transmitter components being disposed in separate chambers (7, 8) that are magnetically shielded from each other to a large extent. The chambers (7, 8) are formed on the components by concentric, radial metal walls of the chamber elements (1, 2), with the concentric walls extending into each other in such a way that they form chambers (7, 8) situated radially one behind the other.

### PRIOR ART

The invention relates to an inductive transmitter, in particular a rotating transmitter, for signal and energy transmission between moving components according to the preamble of the primary claim.

Especially when used in a motor vehicle, such a transmitter should permit for example, bi-directional data transmission between the steering column and the steering wheel, with simultaneous energy transmission from the steering column to the steering wheel. The transmission of energy can be approximately 1 W if only the steering wheel electronics need to be supplied, with an additional 120 W if a steering wheel heater must be supplied as well. Moreover, it is also possible for information to be exchanged regarding the activation of the horn, control buttons for driving comfort, a telephone dialing button, speed regulation (cruise control), certain radio functions, or even monitoring or activation of the air bag.

Conventionally, in such cases, a coiled spring is provided for data transmission and/or a slip ring for energy transmission. However, the coiled spring and slip ring tend by nature to have a relatively high noise level and, at the same time, cause a multitude of problems, such as so-called EMC problems (EMC=electromagnetic compatibility), installation and repair problems, as well as a non-negligible amount of friction and difficulty in producing contact. If the inductive transmission of electrical energy is executed at the same time as data transmission, this may result in cross-talk, particularly since the transmitter has an efficiency of <0.6 and the internal resistance of the secondary side is >15 ohm.

### ADVANTAGES OF THE INVENTION

According to the invention, an inductive transmitter for transmitting measurement data and electrical energy between two components that move in relation to each other, having one primary and one secondary transmitter component, is improved in an advantageous manner using the means stated in the characterizing portion of claim 1. According to the invention, there is one transmitter for transmitting measurement data and one transmitter for transmitting electrical energy. The primary and secondary transmitter components of each transmitter are contained in separate chambers that are magnetically shielded from each other to a large extent and that are formed onto the moving components as concentric, radial metal walls, with the concentric walls extending into each other in such a way that they form chambers situated radially one behind the other.

Thus, it is possible for a metallic chamber element to be disposed in a simple manner on each of the components that move in relation to each other, which chamber elements each have a double U-shape in a radial cross section and whose concentric walls are arranged so that they extend into each other without hindering the rotational movement. It is preferable for this to be applied in such a way that the one set of transmitter components and chamber elements is disposed on the steering shaft of a vehicle and the other set of transmitter components and chamber elements is disposed on the steering column of a vehicle.

The recommended arrangement of two transmitters separated by chamber walls allows the mixture of signal and energy transmission to be prevented in a simple manner. Although the partition in the middle between the two chamber elements does serve as the magnetic component for both components of the transmitter, it does not produce any significant cross-talk because at the frequencies of 50 kHz or a few megahertz that are used in most applications, for example in a motor vehicle, only a magnetic skin effect occurs and the magnetic interactions do not have a disruptive effect.

These and other characteristics of preferred embodiments of the invention can be found in the specification and drawings as well as in the claims, and the individual characteristics that may be realized, alone or together in the form of ancillary combinations, in the embodiments of the invention and in other fields, and that may be considered advantageous and intrinsically patentable embodiments, are hereby included in this application.

### DRAWINGS

One exemplary embodiment of an inductive transmitter according to the invention for signal and energy transmission between components of a rotating transmitter will be explained in detail below with reference to the drawings.

FIGS. 1 and 2 each show a view of a rotating transmitter between a steering shaft and a steering column of a motor vehicle, with separate transmitter components for signal and energy transmission, each in separate chambers.

### DESCRIPTION OF THE EXEMPLARY EMBODIMENT

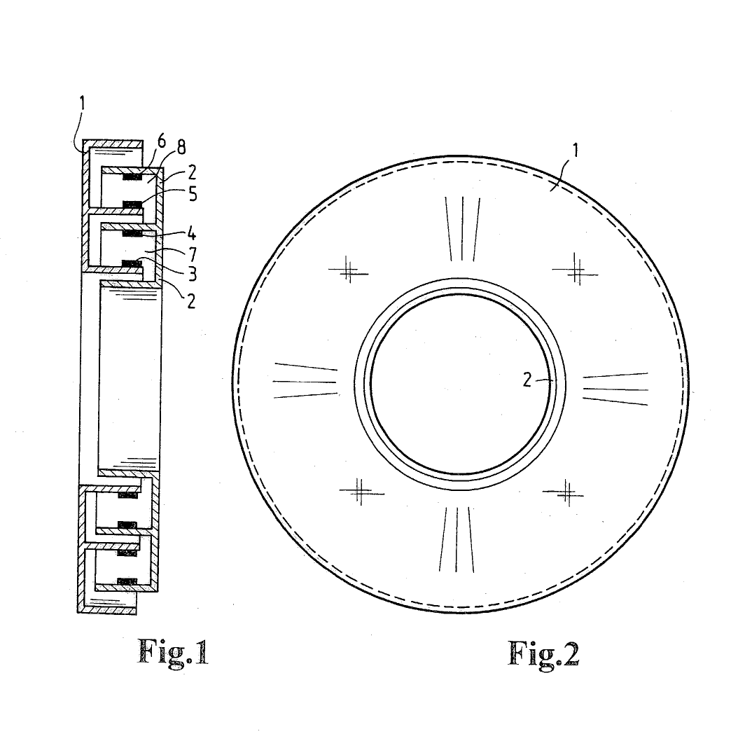

FIG. 1 shows an inductive transmitter having chamber elements 1 and 2, which extend into each other in a comb-like manner and form a component of a motor vehicle steering mechanism, which is not shown or described in greater detail here. By way of example, the chamber element 1 is attached to a steering column and the chamber element 2 is then attached to a steering shaft. In this case, the end of the steering shaft can be rotated by means of a steering wheel, with the steering shaft being attached in rotary fashion to the steering column, which is fixed to the chassis of the vehicle.

An inductive rotating transmitter is provided between the steering shaft and the steering column. For signal transmission, there is a primary transmitter component 3 on the element 1 and a secondary transmitter component 4 on the element 2, and for energy transmission, there is a primary transmitter component 5 on the element 1 and a secondary transmitter component 6 on the element 2. This makes it possible for measurement data and electrical energy to be transmitted between, for example, sensors disposed on the steering shaft and a central evaluation unit in the vehicle.

The embodiment of the concentric, radial walls of the chamber elements 1 and 2, which extend into each other in a comb-like manner, produces a chamber 7 for signal transmission and a chamber 8 for energy transmission. The production of two transmitters separated by chamber walls that is thus achieved allows the mixture of signal and energy transmission to be prevented in a simple manner.

1. An inductive transmitter for transmitting measurement data and electrical energy between two components (1, 2) that move in relation to each other, having at least one primary (3, 5) and at least one secondary transmitter component (4, 6), characterized in that
at least one transmitter (3, 4) is provided for transmitting measurement data and one transmitter (5, 6) is provided for transmitting electrical energy, and in that
the primary (3, 5) and secondary (4, 6) transmitter components of each transmitter are disposed in separate chambers (7, 8) that are magnetically shielded from each other to a large extent, and that are formed on the components (1, 2) by concentric, radial metal walls, with the concentric walls extending into each other in such a way that they form chambers (7, 8) situated radially one behind the other.

2. The inductive transmitter according to claim 1, characterized in that
a metallic chamber element (1, 2) is disposed on each of the components that move in relation to each other, which chamber element has a double U-shape in a radial cross section and whose concentric walls are arranged in such a way that they extend into each other without hindering the rotational movement.

3. The inductive transmitter according to claim 2, characterized in that
one chamber element (2) is disposed on the steering shaft of a vehicle and the other chamber element (1) is disposed on the steering column of a vehicle.
